(19) United States
(12) Patent Application Publication
(10) Pub. No.: US 2012/0267291 A1
(43) Pub. Date: Oct. 25, 2012

(54) Pressure Sensor

(75) Inventor: James Coates, Astwood Bank (GB)

(73) Assignee: QUANTA FLUID SOLUTIONS LTD, Alcester, Warwickshire (GB)

(21) Appl. No.: 13/394,163

(22) PCT Filed: Sep. 3, 2010
(86) PCT No.: PCT/GB2010/001666

§ 371 Date: Jul. 16, 2012

(30) Foreign Application Priority Data
Sep. 3, 2009 (GB) 0915311.5

(51) Int. Cl. B01D 61/30; G01L 7/08

(52) U.S. Cl. 210/90; 73/715

(57) ABSTRACT

A pressure sensor for a dialysis machine, the sensor having a body and a sensing surface, the sensor surface configured to detect the pressure of a fluid across an elastic membrane, the sensor in use generating a vacuum between the sensing surface and the membrane so as to draw the membrane into contact with the sensing surface, wherein the elastic membrane is further retained in use between a sealing surface on the dialysis machine and a membrane engaging surface on the body of the sensor.

### CROSS-REFERENCE TO RELATED APPLICATIONS

This application claims priority from PCT/GB/2010/001666 filed on Sep. 3, 2010, and from GB 0915311.5 filed Sep. 3, 2009, all of which are hereby incorporated by reference in their entireties.

### BACKGROUND OF THE INVENTION

1. Field of the Invention

The present invention relates to pressure sensors and in particular, but not exclusively, to a pressure sensor for use in a disposable hemodialysis cartridge.

2. State of the Art

Dialysis is a treatment which replaces the renal function of removing excess fluid and waste products, such as potassium and urea, from blood. The treatment is either employed when renal function has deteriorated to an extent that uremic syndrome becomes a threat to the body's physiology (acute renal failure) or, when a longstanding renal condition impairs the performance of the kidneys (chronic renal failure).

In hemodialysis, the patient's blood is removed from the body by an arterial line, is treated by the dialysis machine, and is then returned to the body by a venous line. The machine passes the blood through a dialyser containing tubes formed from a semipermeable membrane. On the exterior of the semipermeable membrane is a dialysate solution. The semipermeable membrane filters the waste products and excess fluid from the blood into the dialysate solution. The membrane allows the waste and a controlled volume of fluid to permeate into the dialysate whilst preventing the loss of larger more desirable molecules, like blood cells and certain proteins and polypeptides.

The action of dialysis across the membrane is achieved primarily by a combination of diffusion (the migration of molecules by random motion from a region of higher concentration to a region of lower concentration), and convection (solute movement that results from bulk movement of solvent, usually in response to differences in hydrostatic pressure).

Dialysate composition is critical to successful dialysis treatment since the level of dialytic exchange across the membrane, and thus the possibility to restore adequate body electrolytic concentrations and acid-base equilibrium, depends on the composition. Maintaining the correct pressure in the dialysate and blood fluids is also critical to dialysate treatment.

This management of fluid composition, pressure and flow rate can be achieved on a cartridge which mounts into a dialysis machine as disclosed in WO2006120415. In the machine of WO'415 a cartridge defines channels which are covered by a membrane which is pneumatically operable to displace the fluids on the cartridge. Such a design requires sensing the fluid pressure through the membrane or by penetrating the membrane in order to provide direct access to the fluid.

However, accurately sensing fluid pressure across the membrane is technically challenging due to the resilience of the membrane causing hysteresis in the sensed pressure signal. Attaching the sensor to the membrane can mitigate this problem, but this solution is inappropriate for a cartridge based machine sense for the insertion and removal of the cartridge from the machine becomes impossible.

A known solution is to use a container which carries the fluid to the blood and which inserts into a cavity on the machine. This arrangement is disclosed in EP0130441. The base of the container forms a pressure transmitting wall which abuts a pressure sensor at the base of the cavity. The pressure transmitting wall is attached to the pressure sensor by a vacuum generated between the sensor and the wall.

However, the configuration of the container means that the upright portions of the pressure transmitting wall are compliant to the pressure of the fluid within. This is particularly true when the fluid exerts a negative pressure on the pressure sensor. This in turn introduces hysteresis into the measurement which leads to unwanted inaccuracy in the measurement of the fluid pressure. The solution is also not well suited to a cartridge-based dialysis system which cannot readily accommodate the container design of EP0130441.

### SUMMARY OF THE INVENTION

It is an object of the present invention to provide a pressure sensor which at least mitigates some of the problems described above.

According to a first aspect of the invention there is provided a pressure sensor for a dialysis machine, the sensor having a body and a sensing surface, the sensor surface configured to detect the pressure of a fluid across an elastic membrane, the sensor in use generating a vacuum between the sensing surface and the membrane so as to draw the membrane into contact with the sensing surface, wherein the elastic membrane is further retained in use between a sealing surface on the dialysis machine and a membrane engaging surface on the body of the sensor.

Advantageously, this design allows for very close coupling of the sensing surface of the sensor and the membrane. The deflection by the membrane that is required to attach the membrane to the sensor under the action of the vacuum is minimal. This reduces the compliance in the membrane in the area of the membrane surrounding the vacuum attached portion. This in turn reduces the hysteresis exhibited by the sensor.

Preferably, the sealing surface is defined on the machine by a projection which faces the sensor body.

Preferably, the projection is a continuous upstanding wall.

Preferably, the upstanding wall is cylindrical.

Preferably, the upstanding wall defines an internal pressure sensing volume for receiving the fluid to be sensed.

Preferably, an inner diameter of the sensor body is substantially equal to the inner diameter of the upstanding wall.

Preferably, the pressure sensor of any preceding claims wherein the machine includes a treatment cartridge which defines the sealing surface.

Preferably, the pressure sensor of any one of claims 4 to 7 when dependent on claim 3 wherein the membrane is sealed onto the upstanding wall.

Preferably, the membrane is sealed onto the wall by way of a force applied to the membrane by the sensor.

The clamping of the membrane between the sensor body and the sealing surface retains the membrane tightly in position so as to ensure that any load applied to the membrane by the fluid is detected by the sensor rather than causing unwanted deflection of the membrane.

Preferably, the membrane extends in a continuous plane beyond the sealing surface.

Preferably, the sealing surface is defined by a fluid carrying cartridge adapted for insertion into the machine.

The invention will now be described, by way of example only, and with reference to the following drawings.

### BRIEF DESCRIPTION OF THE DRAWINGS

FIG. 1 is an isometric view of a dialysis machine including the pressure sensor of the present invention,

FIG. 2 is an isometric view of the engine portion of the machine of FIG. 1 including the sensor of the current invention,

FIG. 3 is an isometric view of the cartridge of FIG. 1,

FIGS. 4 to 7 are plan views of the cartridge of FIG. 3,

FIG. 8 is an isometric view of the pressure sensor and pressure sensor chamber of the current invention showing the sensor in the disengaged position, and

FIG. 9 is a sectioned side view of the pressure sensor and pressure sensor chamber of FIG. 8 showing the sensor in the engaged position.

### DETAILED DESCRIPTION OF THE PREFERRED EMBODIMENTS

In FIG. 1 a dialysis machine 1 is shown having a cover 2 which opens to reveal a storage compartment 3. The machine has an engine section 4 which receives a dialysis cartridge 10.

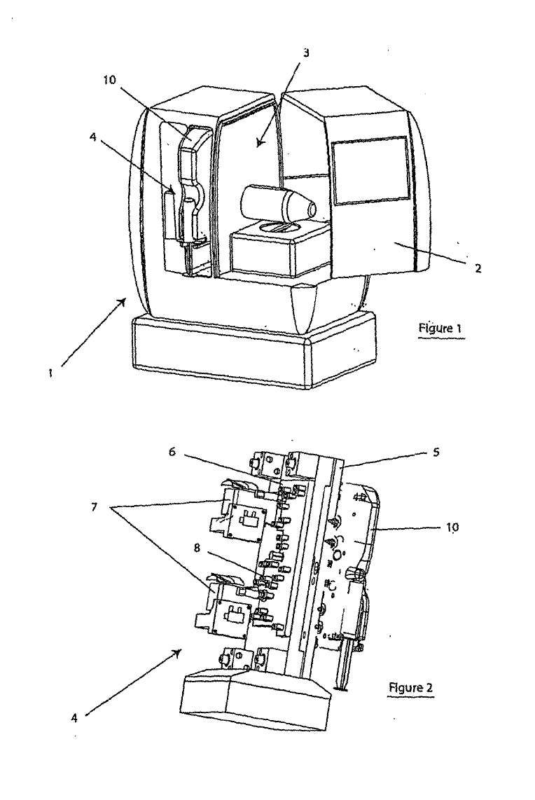

Referring now to FIG. 2, the engine section 4 is shown in further detail to include first and second platens 5, 6 which close upon insertion of the cartridge 10 into the machine to retain the cartridge in position in use. The engine 4 has pneumatic actuators 7 and sensors (indicated generally at 8 in FIG. 2 and discussed in further detail shortly) arranged on the second platen to control operation of the cartridge 10 as will be described in further detail shortly.

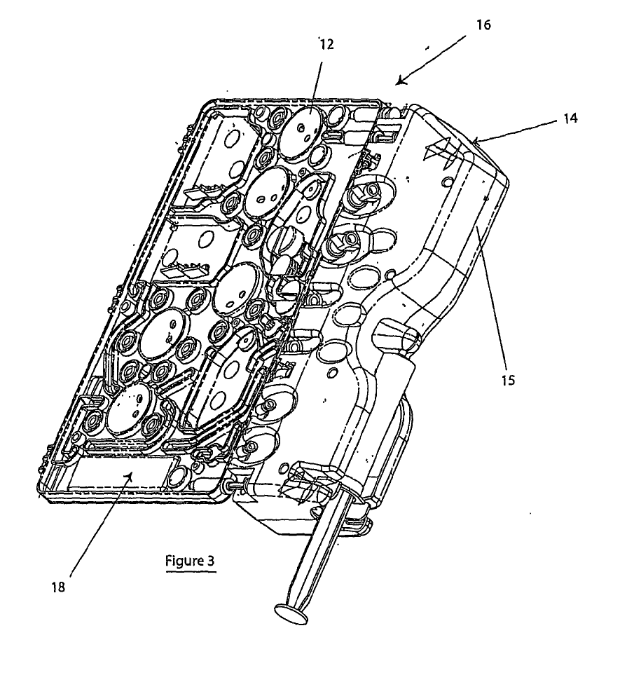

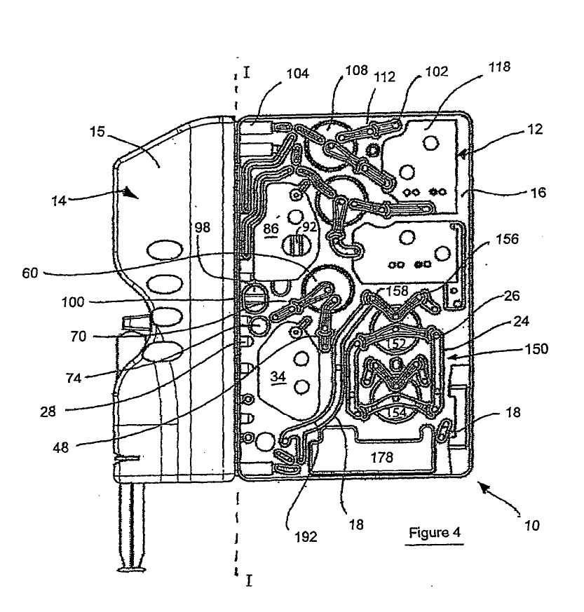

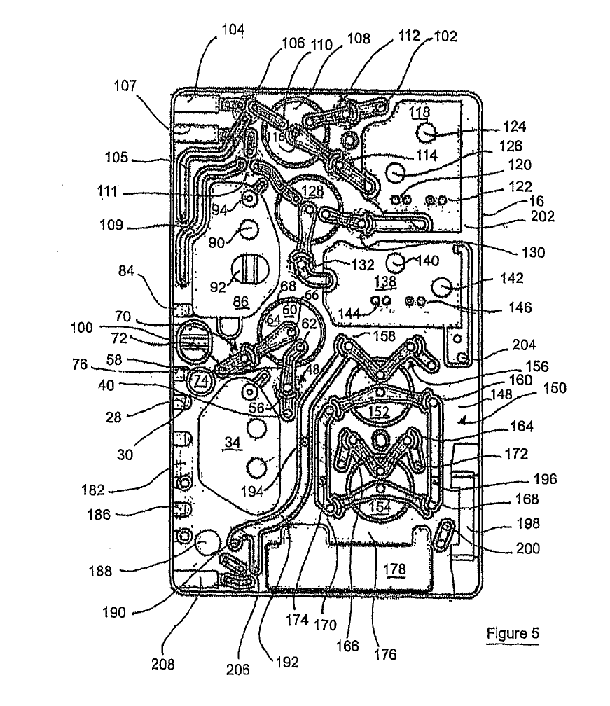

In FIGS. 3 and 4 the dialysis cartridge 10 is shown having a blood pumping portion 12 (to the right of dashed line I-I in FIG. 4) and a dialysate portion 14 (to the left of dashed line I-I in FIG. 4). The blood pumping portion 12 has the form of a flat rectangle. The dialysis portion 14 has a dialyser cover 15.

The blood pumping portion 12 of the dialysis cartridge 10 has an upper surface 16 and a lower surface 18. The upper surface 16 and a lower surface 18 are covered by a clear membranes 20, 22, respectively, which is formed from a deformable plastics material. The first and second membrane, 20, 22 are bonded to the upper surface 16 and a lower surface 18, respectively, by way of adhesive or similar known method.

Referring now to FIG. 4, the upper surface 16 defines a series of upstanding walls indicated, for example, at 24. The upstanding walls 24 define a system of flow channels as will be described in further detail shortly. The channels are enclosed at the outermost part of the upper surface 16, by the first membrane 20. Accordingly, the upper surface 16 defines a series of fluid channels for carrying either the blood to be dialysed, or the dialysate solution.

The cartridge 10 also defines the series of apertures, indicated generally for example at 26 in FIG. 4. These apertures provide a fluid pathway through the cartridge 10, the purpose of which will now be described.

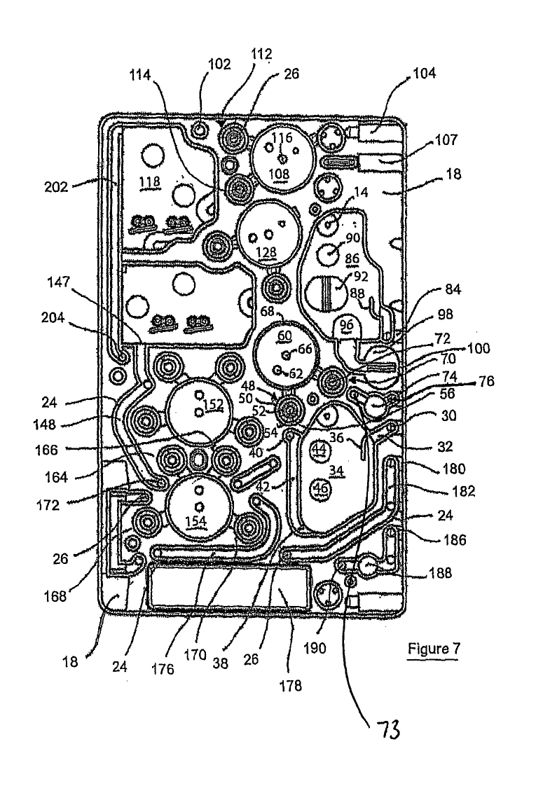

Referring to FIG. 7, the lower surface 18 also defines a series of upstanding walls 24, which collectively define a labyrinth of fluid channels enclosed by the second membrane 22.

In combination, the upper surface 16, lower surface 18 and the first and second membranes 20, 22 form a series of interconnected fluid flow paths on both sides of the blood pumping portion 12. This labyrinth of fluid flow pathways will now be described in further detail.

The first membrane 20 is bonded to the upper surface 16, and similarly the second membrane 22 bonded to the lower surface 18, so as to contain the fluids within their respective channels.

The dialyser cartridge 10 defines two primary fluid pathways, firstly, a flow path for blood and secondly a flow path for the dialysate solution. The blood pathway is formed as follows.

The patient's blood enters the dialysis cartridge 10 via an arterial port 28. The blood then passes from the upper surface 16 to the lower surface 18 via an arterial port aperture 30 where it is then carried by an arterial port channel 32 from the arterial aperture 30 to an arterial blood bubble trap 34. The arterial blood bubble trap 34 has an inlet lip 36 for directing the incoming blood towards the bottom of the trap. Arranged at the bottom of the trap is a blood bubble trap exit 38 which carries the blood from the arterial blood bubble trap 34 to an arterial blood bubble trap aperture 40 via channel 42.

The blood bubble trap 34 is also provided with an upper level sensor port 44 and a lower level sensor port 46. The level sensor ports 44, 46 are arranged to coincide with corresponding optical level sensors arranged on the dialysis machine. Accordingly, the level sensors are able to optically interrogate the arterial blood bubble trap 34 so as to ensure that the level in the blood bubble trap is above the level of the lower level sensor port 46 and below the level of the upper level sensor port 44. It is important to ensure that the blood level remains between these two levels so that there always remains a volume of air in the blood level trap into which any gas bubbles carried in the blood can migrate.

Having passed through the arterial blood bubble trap aperture 40 the blood is carried on the upper surface 16 to a blood pump inlet valve 48 (see FIG. 4).

Referring to FIG. 4, the blood pump inlet valve 48 is operable between a closed condition and an open condition in a known manner.

With the blood pump inlet valve 48 in the open state, the blood flows through the arterial blood bubble trap aperture 40 and into a blood pump 60 via a blood pump inlet 62.

The blood pump is defined by a dome shaped pump cavity 64 into which the blood pump inlet 62 opens. Arranged at the centre of the pump chamber 64 is a pump outlet 66. A volume of blood is drawn into the pump chamber 64, through the open blood pump inlet valve 48 by a negative pressure being applied to the outside surface of the second membrane 22 in order to deform the membrane outwardly away from the lower surface 18. With the pump chamber 64 full, and the pump at full stroke, the blood pump inlet valve 48 is closed and the pump chamber 64 is then evacuated by the dialysis machine applying a positive pressure to the outside surface of the second membrane 22 in order to drive the blood contained within the pump chamber 64 through the pump outlet 66. The pump outlet 66 is in fluid communication with a blood pump outlet valve 70 which is identical in form to the blood pump inlet valve 48. It follows that with the blood pump inlet valve closed, and the blood pump 60 being driven by the dialysis machine to evacuate the pump 64, the blood pump outlet valve 70 is in an open state in order to permit the flow of blood past the valve 70 and through a blood pump outlet valve aperture 72.

Accordingly, the blood pump 60 is in combination with the blood pump inlet valve 48 and the blood pump outlet valve 70. Specifically, the blood pump inlet valve 48 opens when the blood pump is in the expansion stroke in order to admit blood into the pump chamber, whilst the blood pump outlet valve 70 remains closed in order to prevent back-flow of blood through the system. The inlet valve 48 then closes at the same time as the outlet valve 70 is opened in order to allow the compression stroke of the flow pump to drive the blood from the pump chamber 64 and through the blood pump outlet valve aperture 72.

From the aperture 72, the blood then flows into a pressure sensor chamber 74 via inlet 73. As the blood flows through the chamber 74, the fluid pressure causes a force to be applied to the first membrane 20. This force is detected by a pressure sensor 100 (which will be described in further detail shortly) provided in the dialysis machine and this measured force is calibrated to generate a blood pressure reading for the blood within the cartridge.

From the pressure sensor chamber 74 the blood then passes through a sensor output port 76.

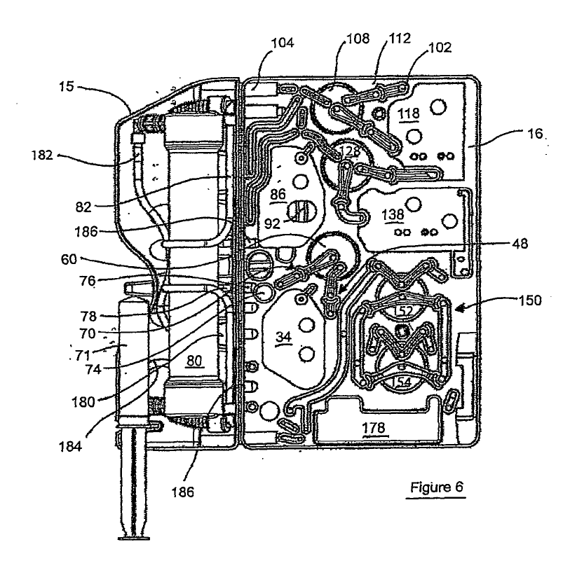

Referring now to FIG. 6, the blood flows from the dialyser blood port 66 down a dialyser blood line 78 and into the bottom end of a dialyser 80 of known design. The dialyser 80 contains multiple axially extending semi-permeable tubes through which the blood passes. Upon exiting the dialyser 80 the blood travels down a dialyser return blood line 82 before passing into a venous blood bubble trap 86 via a dialyser blood return port 84.

The venous blood bubble trap 86 is similar in design to the arterial blood bubble trap 34 in that it has an inlet lip 88, an optical level sensor 90 and a hydrophilic membrane 94 to allow the hydrolysis machine withdraw or administer a volume of air to or from the bubble trap in order to maintain a constant blood level within the bubble trap. The venous blood level trap 86 is further provided with an ultrasonic level sensor 92 the design of which will be described in further detail shortly. At the bottom end of the valve trap is a thrombus filter 96 for trapping blood clots within the bubble trap. The thrombus filter may be of conical form as in known thrombus filters or may be wedge shaped. Having passed through the thrombus filter 96, the blood passes through an ultrasonic flow rate sensor 98 which will be described in further detail shortly. The blood is then returned to the patient via a venous port 99.

The blood therefore completes its passage through the dialysis cartridge 10 from the arterial port 28 through the arterial blood bubble trap 34, the blood pump inlet valve 48 and into the blood pump 60. From blood pump 60 the blood is driven past the blood pump outlet valve 70 and into the dialyser 80 via the pressure sensor chamber 74. Upon exit from the dialyser 80, the blood is returned to the dialysis cartridge 10 via the dialyser blood return port 84. Upon exit from the port 84 the blood enters the venous blood bubble trap 86, passes through the thrombus filter 96 and flow sensor 98 before being returned to the patient via the venous port 99.

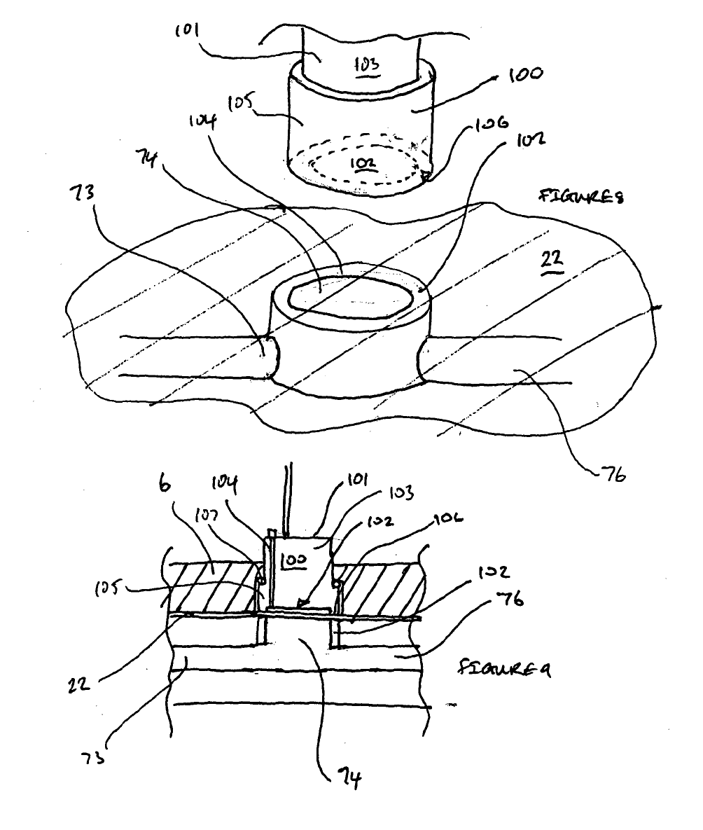

The pressure sensor 100 will now be described in further detail with reference to FIGS. 8 and 9. The pressure sensor chamber 74 is defined on the cartridge by a upstanding cylindrical wall 102 which has an inlet 73 and an outlet 76 to allow the flow of blood through the chamber 74. The top of the wall 102 defines a flat sealing surface 104 which supports the membrane 22. The upstanding wall forms a continuous anullar sealing surface but is conceivable within the scope of the invention that the surface could have a different shape.

The sensor 100 has a sensor body 101 which houses a sensing surface 102 which engages the membrane 22 by applying a vacuum to the surface of the membrane. This vacuum is applied to the membrane via a vacuum port 104 which passes through the sensor body 101 for attachment to a vacuum line (not shown for clarity) in a known manner. The body has an upper portion 103 and a lower portion 105 which is flanged outwardly to receive a seal 107 for engaging the platen 6.

The body 101 of the sensor 100 defines a membrane engagement surface 106 which engages the sealing surface 102 of the cartridge to retain the membrane 22 in position to permit sensing. The inner diameter of the sealing surface 102 is substantially the same as the inner diameter of the membrane engagement surface 106. This ensures the close coupling of the membrane to the pressure sensing surface 102.

This arrangement limits the hysteresis exhibited by the membrane since the membrane is tightly retained in position and undergoes minimal deflection when the vacuum is applied to the membrane in order to attach it to the sensing surface.

Whilst the sensor is described herein with reference to a blood flow path, the sensor could be equally well used to detect the pressure of water, or partly or fully formed dialysate solution, or other suitable medical liquid used in dialysis, across a membrane.

1. A pressure sensor for a dialysis machine, the pressure sensor comprising:
a body, an elastic membrane, and a sensing surface, the sensing surface configured to detect pressure of a fluid across the membrane, the pressure sensor in use generating a vacuum between the sensing surface and the membrane so as to draw the membrane into contact with the sensing surface, wherein the membrane is further retained in use between a sealing surface on the dialysis machine and a membrane engaging surface on the body of the pressure sensor.

2. The pressure sensor of claim 1, wherein:
the sealing surface is defined on the dialysis machine by a projection which faces the body of the pressure sensor.

3. The pressure sensor of claim 2, wherein:
the projection is a continuous upstanding wall.

4. The pressure sensor of claim 3, wherein:
the upstanding wall is cylindrical.

5. The pressure sensor of claim 3, wherein:
the upstanding wall defines an internal pressure sensing volume for receiving the fluid to be sensed.

6. The pressure sensor of claim 1, wherein:
the inner profile of the membrane engaging surface is substantially the same as the inner profile of the sealing surface.

7. The pressure sensor of claim 1, wherein:
the dialysis machine includes a treatment cartridge which defines the sealing surface.

8. The pressure sensor of on claim 3, wherein:
the membrane is sealed onto the upstanding wall.

9. The pressure sensor of claim 8, wherein:
the membrane is sealed onto the wall by way of a force applied to the membrane by the pressure sensor.

10. The pressure sensor of claim 1, wherein:
the membrane extends in a continuous plane beyond the sealing surface.

11. A dialysis machine comprising:
a pressure sensor having a body, an elastic membrane, and a sensing surface, the sensing surface configured to detect pressure of a fluid across the membrane, the pressure sensor in use generating a vacuum between the sensing surface and the membrane so as to draw the membrane into contact with the sensing surface, wherein the membrane is further retained in use between a sealing surface on the dialysis machine and a membrane engaging surface on the body of the pressure sensor.

12. The dialysis machine of claim 11, wherein:
the sealing surface is defined on the dialysis machine by a projection which faces the body of the pressure sensor.

13. The dialysis machine of claim 12, wherein:
the projection is a continuous upstanding wall.

14. The dialysis machine of claim 13, wherein:
the upstanding wall is cylindrical.

15. The dialysis machine of claim 13, wherein:
the upstanding wall defines an internal pressure sensing volume for receiving the fluid to be sensed.
